(19) United States
(12) Patent Application Publication
(10) Pub. No.: US 2020/0313291 A1
(43) Pub. Date: Oct. 1, 2020

(54) ANTENNA APPARATUS

(71) Applicant: PANASONIC INTELLECTUAL PROPERTY MANAGEMENT CO., LTD., Osaka (JP)

(72) Inventors: Koichi TSUMURA, Kanagawa (JP); Toshihiro OKUDA, Tokyo (JP); Yuki IIDA, Kanagawa (JP)

(73) Assignee: PANASONIC INTELLECTUAL PROPERTY MANAGEMENT CO., LTD., Osaka (JP)

(21) Appl. No.: 16/830,949

(22) Filed: Mar. 26, 2020

(30) Foreign Application Priority Data
Mar. 28, 2019 (JP) 2019-064965

(51) Int. Cl. H01Q 1/48; H01Q 21/06

(52) U.S. Cl. CPC H01Q 1/48; H01Q 21/06

(57) ABSTRACT

An antenna apparatus capable of being downsized while preventing performance degradation is provided. Antenna apparatus includes: first antenna; second antenna; first ground plane to which first antenna is connected via first power feeder; and second ground plane to which second antenna is connected via second power feeder. In antenna apparatus, first ground plane and second ground plane are provided substantially in parallel with each other.

### TECHNICAL FIELD

The present disclosure relates to an antenna apparatus.

### BACKGROUND ART

Conventionally, as one of techniques for improving communication speeds in radio systems, a technique of Multiple Input Multiple Output (MIMO) for performing communication using a plurality of antennas has been known.

For example, Patent Literature (hereinafter, referred to as “PTL”) 1 discloses a MIMO antenna apparatus including a rectangular board, two inverted-F antennas disposed on one short side of the board, and two slit-type monopole antennas disposed respectively on both long sides of the board.

### CITATION LIST

### Patent Literature

PTL 1 Japanese Patent Application Laid-Open No. 2010-130115

### SUMMARY OF INVENTION

### Technical Problem

An object of the present disclosure is to provide an antenna apparatus capable of being downsized while preventing performance degradation.

### Solution to Problem

An antenna apparatus according to one aspect of the present disclosure includes a first antenna; a second antenna; a first ground plane to which the first antenna is connected via a first power feeder; and a second ground plane to which the second antenna is connected via a second power feeder, in which the first ground plane and the second ground plane are provided substantially in parallel with each other.

### Advantageous Effects of Invention

According to the present disclosure, it is made possible to provide an antenna apparatus capable of being downsized while preventing performance degradation.

### BRIEF DESCRIPTION OF DRAWINGS

FIG. 1A is a diagram illustrating a configuration example of an antenna apparatus with one ground plane;

FIG. 1B is a diagram illustrating a configuration example of an antenna apparatus with two ground planes;

FIG. 2A is a diagram indicating a relationship between a distance between two ground planes and a correlation coefficient between antennas;

FIG. 2B is a diagram indicating a relationship between the distance between the two ground planes and an antenna efficiency of a first antenna;

FIG. 2C is a diagram indicating a relationship between a distance between two ground planes and an antenna efficiency of a second antenna;

FIG. 3 is a diagram for describing a relationship between the distance between two ground planes and performance improvement;

FIG. 4A is a diagram illustrating a configuration example of an antenna apparatus in a case where the number of antennas is four;

FIG. 4B is a diagram illustrating another configuration example of the antenna apparatus in a case where the number of antennas is four; and

FIG. 5 is a diagram illustrating a configuration example of an antenna apparatus in which no notch is provided in a second ground plane in a case where the first ground plane and the second ground plane are present.

### DESCRIPTION OF EMBODIMENTS

Hereinafter, an embodiment of the present disclosure will be described in detail with reference to the accompanying drawings.

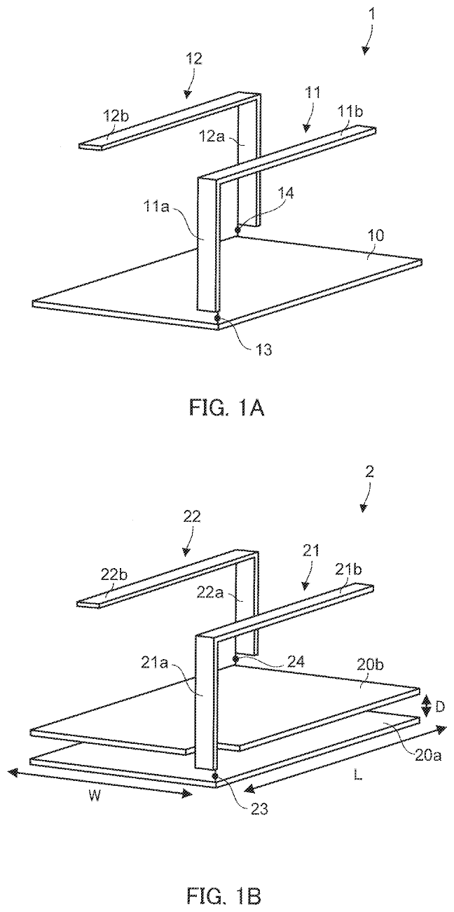

FIG. 1A is a diagram illustrating a configuration example of antenna apparatus 1 with one ground plane, and FIG. 1B is a diagram illustrating a configuration example of antenna apparatus 2 with two ground planes, according to the present embodiment.

Antenna apparatus 1 illustrated in FIG. 1A includes ground plane 10, first antenna 11, and second antenna 12.

First antenna 11 is an inverted-L antenna and includes first element 11a extending perpendicularly with respect to ground plane 10 of a rectangular shape, and second element 11b extending along a long side of ground plane 10.

First antenna 11 is connected to a corner portion of ground plane 10 via first power feeding point 13.

Second antenna 12 is also an inverted-L antenna and includes third element 12a extending perpendicularly with respect to ground plane 10 on the same side as first element 11a of first antenna 11, and fourth element 12b extending along the long side of ground plane 10.

Further, second antenna 12 is connected via second power feeding point 14 to a corner portion of ground plane 10 which is positioned diagonally to the corner portion where first power feeding point 13 is positioned.

The direction in which fourth element 12b of second antenna 12 extends from third element 12a is opposite to the direction in which second element 11b of first antenna 11 extends from first element 11a.

Second element 11b of first antenna 11 is provided so as to be positioned at the same height as fourth element 12b of second antenna 12 as viewed from ground plane 10.

Meanwhile, antenna apparatus 2 according to the present embodiment illustrated in FIG. 1B includes first ground plane 20a, second ground plane 20b, first antenna 21, and second antenna 22.

First ground plane 20a and second ground plane 20b, herein, are provided in parallel with each other. Note that, provision of first ground plane 20a and second ground plane 20b strictly in parallel with each other is not necessarily required for obtaining the operational effects of the present disclosure, and obviously, a certain error is tolerable.

That is, it is sufficient as long as first ground plane 20a and second ground plane 20b are provided substantially in parallel with each other. In other words, this means that first ground plane 20a and second ground plane 20b extend substantially in the same direction. Further, the shapes of first ground plane 20a and second ground plane 20b need not be the shapes which completely overlap each other.

First antenna 21 is an inverted-L antenna and includes first element 21a extending perpendicularly with respect to first ground plane 20a of a rectangular shape and second element 21b extending along a long side of first ground plane 20a.

Further, first antenna 21 is connected to a corner portion of first ground plane 20a via first power feeding point 23.

Herein, a notch is formed in second ground plane 20b for the purpose of achieving downsizing of antenna apparatus 2 by extending first element 21a perpendicularly with respect to first ground plane 20a without causing first element 21a to protrude outward.

Second antenna 22 is also an inverted-L antenna and includes third element 22a extending perpendicularly with respect to first ground plane 20a on the same side as first element 21a of first antenna 21, and fourth element 22b extending along a long side of second ground plane 20b.

Second antenna 22 is connected via second power feeding point 24 to a corner portion of second ground plane 20b which is positioned diagonally to a corner portion of first ground plane 20a where first power feeding point 23 is positioned.

The direction in which fourth element 22b of second antenna 22 extends from third element 22a is substantially opposite to the direction in which second element 21b of first antenna 21 extends from first element 21a.

Second element 21b of first antenna 21 is provided so as to be positioned at the same height as fourth element 22b of second antenna 22 as viewed from second ground plane 20b.

In antenna apparatus 1 illustrated in FIG. 1A, the two antennas (first antenna 11 and second antenna 12) are provided on one ground plane 10, thereby, causing antenna coupling to occur, and thus, causing a decrease in antenna efficiency and an increase in correlation coefficients.

In order to prevent the above described situation, it is possible to make ground plane 10 larger in size, but larger ground plane 10 makes downsizing of antenna apparatus 1 difficult.

Meanwhile, in antenna apparatus 2 illustrated in FIG. 1B, a configuration is adopted in which first antenna 21 and second antenna 22 are connected to the two ground planes (first ground plane 20a and second ground plane 20b) that are parallel to each other, via first power feeding point 23 and second power feeding point 24, respectively.

With this configuration, downsizing is made possible while degradation of antenna performance is prevented. Hereinafter, the antenna performance of antenna apparatus 2 according to the present embodiment will be described.

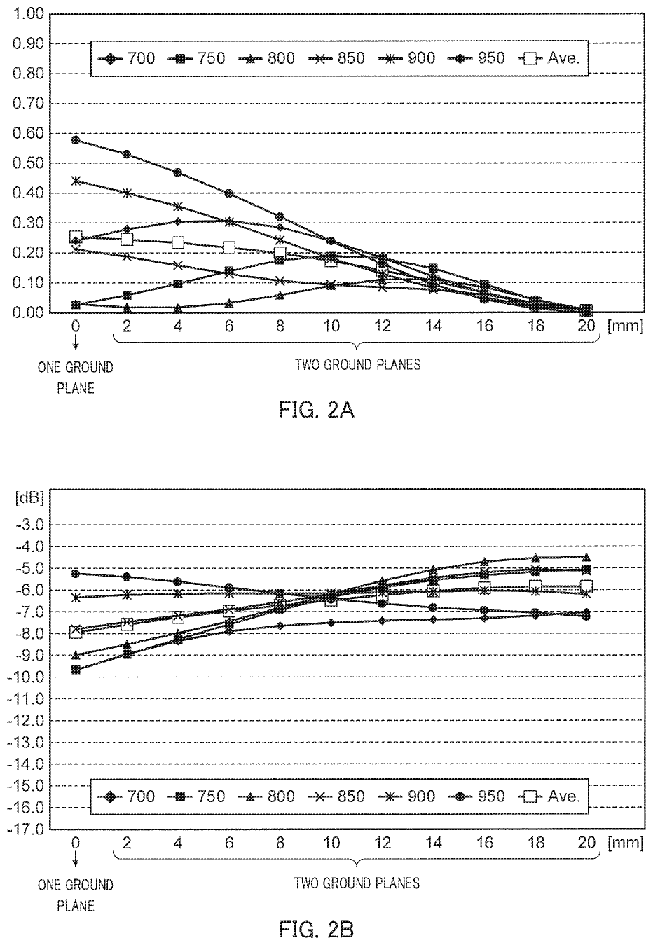

FIG. 2A is a diagram indicating a relationship between a distance between the two ground planes and the correlation coefficient between the antennas. FIG. 2B is a diagram indicating a relationship between a distance between the two ground planes and the antenna efficiency of first antenna 21. FIG. 2C is a diagram indicating a relationship between a distance between the two ground planes and the antenna efficiency of second antenna 22.

FIG. 2A, FIG. 2B, and FIG. 2C indicate values of simulation results of correlation coefficients or antenna efficiency with respect to the distances between the ground planes (horizontal axis, in millimeters). Simulations are conducted for a plurality of frequencies (700, 750, 800, 850, 900, and 950 MHz), and FIGS. 2A, 2B, and 2C indicate the transition of values of the correlation coefficients or the antenna efficiency between the antennas with respect to the distance between the ground planes for each frequency, and further indicate their mean values.

Herein, 0 mm on the horizontal axis indicates that one ground plane is used. Further, the scale after 0 mm on the horizontal axis represents the distance between two ground planes, and the distance between first ground plane 20a and second ground plane 20b illustrated in FIG. 1B increases by 2 mm.

As illustrated in FIG. 2A, the correlation coefficient between the antennas decreases as the distance between the two ground planes increases, with reference to the mean values of the correlation coefficients. In other words, it can be said that the correlation coefficient between the antennas tends to improve as the distance between the two ground planes increases.

As illustrated in FIG. 2B, the antenna efficiency of first antenna 11 also increases as the distance between the two ground planes increases, with reference to the mean values of the antenna efficiency. That is, it can be said that the antenna efficiency of first antenna 11 tends to improve as the distance between the two ground planes increases.

Further, as illustrated in FIG. 2C, it can be said that the antenna efficiency of second antenna 12 exhibits substantially the same or even better performance than that of the case of one ground plane when the distance between the two ground planes is up to 12 mm, and the antenna efficiency tends to improve when the distance between ground planes is at least up to 12 mm.

As described above, the reason for the performance improvement in antenna apparatus 2 illustrated in FIG. 1B is that, since the antennas are respectively disposed on two ground planes provided in parallel with each other as illustrated in FIG. 1B, the symmetry of the current distributions and the radiation patterns of antenna apparatus 2 is broken as compared with the symmetry of the current distributions and the radiation patterns of antenna apparatus 1 illustrated in FIG. 1A.

Next, a description will be given of a relationship between the distance between first ground plane 20a and second ground plane 20b and the performance improvement in antenna apparatus 2 illustrated in FIG. 1B.

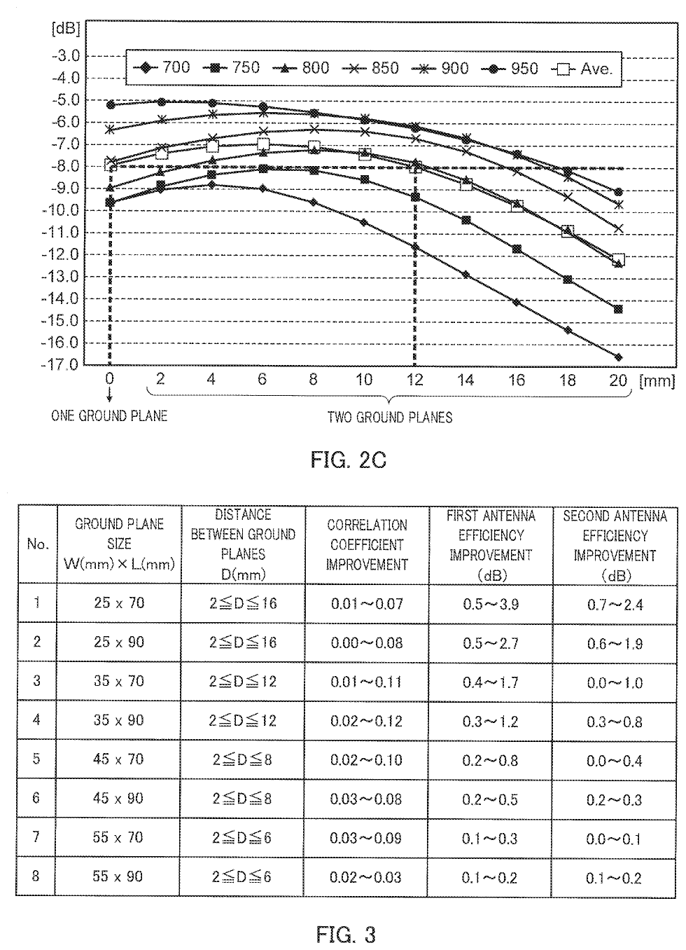

FIG. 3 is a diagram illustrating the relationship between the distance between first ground plane 20a and second ground plane 20b and the performance improvement in antenna apparatus 2.

FIG. 3 indicates the results of simulations conducted on eight antenna apparatuses 2 having different sizes.

More specifically, eight results of simulations are indicated, which are conducted while distance D between first ground plane 20a and second ground plane 20b is changed in a case where the lengths of the short sides of first ground plane 20a and second ground plane 20b are the same W, and the lengths of the long sides thereof are the same L.

The evaluation values of the improvement of the correlation coefficients, the efficiency improvement of first antenna 21, and the efficiency improvement of second antenna 22 in FIG. 3 are average values of bands from 700 MHz to 950 MHz. The evaluation values of the improvement of the correlation coefficients and the efficiency improvement are values representing the degree of the improvement with respect to the correlation coefficients or the efficiency in the case of one ground plane.

As illustrated in FIG. 3, it can be said that the correlation coefficients and the efficiency of first antenna 21 are improved in all of the eight antenna apparatuses having different sizes (except for correlation coefficient for 25×70), by adopting a configuration in which two ground planes are used, as compared with the case of one ground plane.

Further, the efficiency of second antenna 22 is not degraded (is slightly improved) as compared with the case of one ground plane.

Herein, it is regarded as a remarkable improvement in a case where a stable improvement is observed in correlation coefficients and there is a case where the efficiency of first antenna 21 exceeds 0.3 dB.

In this case, it can be said that remarkable improvements are present in the cases of No. 3 to No. 6 among the cases of No. 1 to No. 8 indicated in FIG. 3.

In these cases, when length L of the long sides of first ground plane 20a and second ground plane 20b is equal to or greater than 70 mm and is not greater than 90 mm, and the length W of the short sides of first ground plane 20a and second ground plane 20b is (25+t) mm (where t is equal to or greater than 10 and is not greater than 20), the distance between first ground plane 20a and second ground plane 20b is equal to or greater than 2 mm and is not greater than (16−2t/5) mm.

That is, it can be said that the antenna performance is remarkably improved when the conditions as described above are satisfied. For example, when W=35 mm and t=10, D is 12 mm or less, and when W=45 mm and t=20, D is 8 mm or less.

Note that, the cases described herein are only a description of dimensions with which a remarkable effect can be obtained when a configuration in which two ground planes are used is adopted, and obviously, a certain improvement effect can be obtained even when t is smaller than 10 or larger than 20 by adopting the configuration in which two ground planes are used.

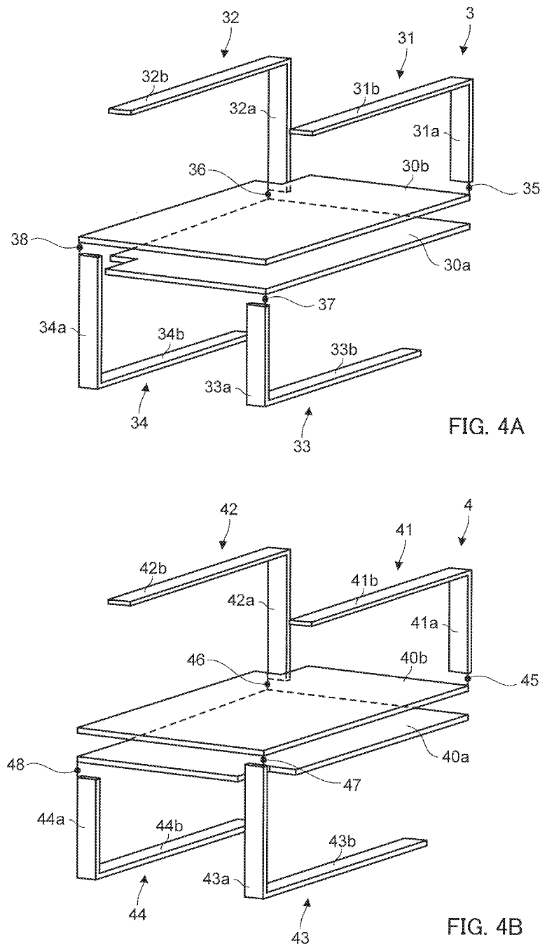

Next, a case where the number of antennas is more than two will be described. FIG. 4A is a diagram illustrating a configuration example of antenna apparatus 3 when the number of antennas is four, and FIG. 4B is a diagram illustrating another configuration example of antenna apparatus 4 when the number of antennas is four.

Antenna apparatus 3 illustrated in FIG. 4A includes first ground plane 30a, second ground plane 30b, first antenna 31, second antenna 32, third antenna 33, and fourth antenna 34.

First ground plane 30a and second ground plane 30b are provided in parallel with each other, herein.

First antenna 31 is an inverted-L antenna and includes first element 31a extending perpendicularly with respect to second ground plane 30b of a rectangular shape, and second element 31b extending along a long side of second ground plane 30b.

Further, first antenna 31 is connected to a corner portion of second ground plane 30b via first power feeding point 35.

Second antenna 32 is also an inverted-L antenna and includes third element 32a extending perpendicularly with respect to first ground plane 30a on the same side as first element 31a of first antenna 31, and fourth element 32b extending along the long side of second ground plane 30b.

Second antenna 32 is connected via second power feeding point 36 to a corner portion of first ground plane 30a on the same side as the corner portion of second ground plane 30b where first power feeding point 35 is positioned.

Herein, a notch is formed in second ground plane 30b for the purpose of achieving downsizing of antenna apparatus 3 by extending third element 32a perpendicularly with respect to first ground plane 30a without causing third element 32a to protrude outward.

The direction in which fourth element 32b of second antenna 32 extends from third element 32a is the same as the direction in which second element 31b of first antenna 31 extends from first element 31a.

Further, second element 31b of first antenna 31 is provided so as to be positioned at the same height as fourth element 32b of second antenna 32 as viewed from second ground plane 30b.

Third antenna 33 is also an inverted-L antenna and includes fifth element 33a extending perpendicularly with respect to first ground plane 30a on a side opposite to a side of first element 31a of first antenna 31, and sixth element 33b extending along a long side of first ground plane 30a.

Third antenna 33 is connected via third power feeding point 37 to a corner portion of first ground plane 30a which is positioned diagonally to the corner portion of second ground plane 30b where second power feeding point 36 is positioned.

Fourth antenna 34 is also an inverted-L antenna and includes seventh element 34a extending perpendicularly with respect to second ground plane 30b on the side opposite to first element 31a of first antenna 31, and eighth element 34b extending along the long side of first ground plane 30a.

Fourth antenna 34 is connected via fourth power feeding point 38 to a corner portion of second ground plane 30b on the same side as the corner portion of first ground plane 30a where third power feeding point 37 is positioned.

Herein, a notch is formed in first ground plane 30a for the purpose of achieving downsizing of antenna apparatus 3 by extending seventh element 34a perpendicularly with respect to second ground plane 30b without causing seventh element 34a to protrude outward.

The direction in which eighth element 34b of fourth antenna 34 extends from seventh element 34a is the same as the direction in which sixth element 33b of third antenna 33 extends from fifth element 33a.

Sixth element 33b of third antenna 33 is provided so as to be positioned at the same height as eighth element 34b of fourth antenna 34 as viewed from first ground plane 30a.

Antenna apparatus 4 illustrated in FIG. 4B includes first ground plane 40a, second ground plane 40b, first antenna 41, second antenna 42, third antenna 43, and fourth antenna 44.

First ground plane 40a and second ground plane 40b, herein, are provided in parallel with each other.

First antenna 41 is an inverted-L antenna and includes first element 41a extending perpendicularly with respect to second ground plane 40b of a rectangular shape, and second element 41b extending along a long side of second ground plane 40b.

Further, first antenna 41 is connected to a corner portion of second ground plane 40b via first power feeding point 45.

Second antenna 42 is also an inverted-L antenna and includes fourth element 42a extending perpendicularly with respect first ground plane 40a on the same side as first element 41a of first antenna 21, and fourth element 42b extending along the long side of second ground plane 40b.

Second antenna 42 is connected via second power feeding point 46 to a corner portion of first ground plane 40a on the same side as the corner portion of second ground plane 40b where first power feeding point 45 is positioned.

Herein, a notch is formed in second ground plane 40b for the purpose of achieving downsizing of antenna apparatus 4 by extending third element 42a perpendicularly with respect to first ground plane 40a without causing third element 42a to protrude outward.

The direction in which fourth element 42b of second antenna 42 extends from third element 42a is the same as the direction in which second element 41b of first antenna 41 extends from first element 41a.

Further, second element 41b of first antenna 41 is provided so as to be positioned at the same height as fourth element 42b of second antenna 42 as viewed from second ground plane 40b.

Third antenna 43 is also an inverted-L antenna and includes fifth element 43a extending perpendicularly with respect to first ground plane 40a on a side opposite to first element 41a of first antenna 41, and sixth element 43b extending along a long side of first ground plane 40a.

Third antenna 43 is connected via third power feeding point 47 to a corner portion of second ground plane 40b which is positioned diagonally to the corner portion of first ground plane 40a where second power feeding point 46 is positioned.

Herein, a notch is formed in first ground plane 40a for the purpose of achieving downsizing of antenna apparatus 4 by extending fifth element 43a perpendicularly with respect to second ground plane 40b without causing fifth element 43a to protrude outward.

Fourth antenna 44 is also an inverted-L antenna and includes seventh element 44a extending perpendicularly with respect to first ground plane 40a on a side opposite to a side of first element 41a of first antenna 41, and eighth element 44b extending along the long side of first ground plane 40a.

Fourth antenna 44 is connected via fourth power feeding point 48 to a corner portion of first ground plane 40a on the same side as the corner portion of second ground plane 40b where third power feeding point 47 is positioned.

The direction in which eighth element 44b of fourth antenna 44 extends from seventh element 44a is the same as the direction in which sixth element 43b of third antenna 43 extends from fifth element 43a.

Sixth element 43b of third antenna 43 is provided so as to be positioned at the same height as eighth element 44b of fourth antenna 44 as viewed from first ground plane 40a.

In antenna apparatuses 3 and 4 illustrated in FIGS. 4A and 4B, the symmetry of the current distributions and the radiation patterns of antenna apparatuses 3 and 4 is broken as in the case of antenna apparatus 2 illustrated in FIG. 1B. Therefore, the correlation coefficients and the efficiency of the antennas are remarkably improved.

In the above embodiment, for the purpose of downsizing antenna apparatuses 2 to 4, the notches are formed in the ground planes and the antenna elements are caused to pass through the notches, but the notches need not necessarily be provided as long as a required amount of downsizing is achieved.

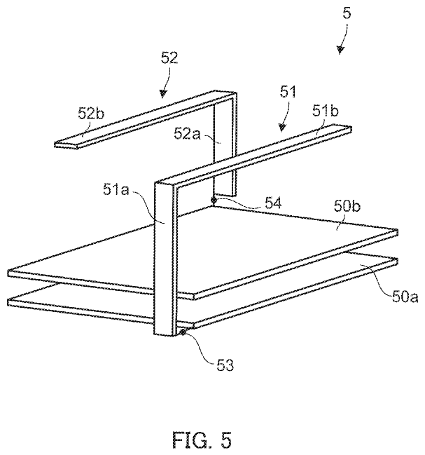

FIG. 5 is a diagram illustrating a configuration example of antenna apparatus 5 in which no notch is provided in second ground plane 50b in a case where first ground plane 50a and second ground plane 50b are present.

Antenna apparatus 5 includes first ground plane 50a, second ground plane 50b, first antenna 51, and second antenna 52.

First ground plane 50a and second ground plane 50b, herein, are provided in parallel with each other.

First antenna 51 is an inverted-L antenna and includes first element 51a extending perpendicularly with respect to first ground plane 50a of a rectangular shape, and second element 51b extending along a long side of first ground plane 50a.

First antenna 51 is connected to a corner portion of first ground plane 50a via first power feeding point 53.

However, unlike antenna apparatus 2 illustrated in FIG. 1B, second ground plane 50b does not have a notch through which first element 51a is caused to pass, and first element 51a passes an outer side of second ground plane 50b and extends perpendicularly with respect to first ground plane 50a.

Second antenna 52 is also an inverted-L antenna and includes third element 52a extending perpendicularly with respect to first ground plane 50a on the same side as first element 51a of first antenna 51, and fourth element 52b extending along a long side of second ground plane 50b.

Second antenna 52 is connected via second power feeding point 54 to a corner portion of second ground plane 50b which is positioned diagonally to the corner portion of first ground plane 50a where first power feeding point 53 is positioned.

The direction in which fourth element 52b of second antenna 52 extends from third element 52a is substantially opposite to the direction in which second element 51b of first antenna 51 extends from first element 51a.

Second element 51b of first antenna 51 is provided so as to be positioned at the same height as fourth element 52b of second antenna 52 as viewed from second ground plane 50b.

In this case, as in the case of antenna apparatus 2 illustrated in FIG. 1B, the symmetry of the current distributions and the radiation patterns of antenna apparatus 5 is broken. Therefore, the correlation coefficient and the efficiency of the antenna are remarkably improved.

In the embodiment described above, the description has been given with an inverted-L antenna in which an element is partly bent (may be referred to as “partly-bent element” hereinafter), as an example, but the technical scope of the present disclosure is not limited to the inverted-L antenna, and may be, for example, a monopole antenna, a loop antenna, or another linear antenna or a dipole antenna, and is not particularly limited.

The antenna apparatus according to the present disclosure further includes a third antenna, in which the third antenna is connected to the first ground plane via a third power feeder, and in which the third antenna is provided on a side of the first ground plane and the second ground plane which is opposite to a side of the first antenna and the second antenna.

The antenna apparatus according to the present disclosure further includes a fourth antenna, in which the fourth antenna is connected to the second ground plane via a fourth power feeder, and in which the fourth antenna is provided on a side of the first ground plane and the second ground plane which is opposite to a side of the first antenna and the second antenna.

In the antenna apparatus according to the present disclosure, the second ground plane includes a notch through which the first antenna passes.

The antenna apparatus according to the present disclosure further includes a third antenna and a fourth antenna, in which the third antenna is connected to the first ground plane via a third power feeder, and the fourth antenna is connected to the second ground plane via a fourth power feeder, and in which the third antenna and the fourth antenna are provided on a side of the first ground plane and the second ground plane which is opposite to a side of the first antenna and the second antenna.

In the antenna apparatus according to the present disclosure, the third antenna is connected to another corner portion of the first ground plane positioned diagonally to the corner portion of the first ground plane where the second antenna is connected, and in which the fourth antenna is connected to a corner portion of the second ground plane positioned diagonally to a corner portion of the second ground plane where the first antenna is connected.

In the antenna apparatus according to the present disclosure, the third antenna and the fourth antenna each include a partly-bent element.

In the antenna apparatus according to the present disclosure, a portion of the partly-bent element in the third antenna and a portion of the partly-bent element of the fourth antenna extend in a same direction.

In the antenna apparatus according to the present disclosure, the first ground plane includes, at a corner portion of the first ground plane, a notch through which the fourth antenna passes.

The antenna apparatus according to the present disclosure further includes a third antenna and a fourth antenna, in which the third antenna is connected to the second ground plane via a third power feeder, and the fourth antenna is connected to the first ground plane via a fourth power feeder, and in which the third antenna and the fourth antenna are provided on a side of the first ground plane and the second ground plane which is opposite to a side of the first antenna and the second antenna.

In the antenna apparatus according to the present disclosure, the third antenna is connected to a corner portion of the second ground plane positioned diagonally to the corner portion of the first ground plane where the second antenna is connected, and in which the fourth antenna is connected to a corner portion of the first ground plane positioned diagonally to the corner portion of the second ground plane where the first antenna is connected.

In the antenna apparatus according to the present disclosure, the third antenna and the fourth antenna each include a partly-bent element.

In the antenna apparatus according to the present disclosure, a portion of the partly-bent element in the third antenna and a portion of the partly-bent element of the fourth antenna extend in a same direction.

In the antenna apparatus according to the present disclosure, the first ground plane includes, at a corner portion of the first ground plane, a notch through which the third antenna passes.

While various embodiments have been described herein above, it is to be appreciated that various changes in form and detail may be made without departing from the sprit and scope of the invention(s) presently or hereafter claimed.

This application is entitled to and claims the benefit of Japanese Patent Application No. 2019-064965, filed on Mar. 28, 2019, the disclosure of which including the specification, drawings and abstract is incorporated herein by reference in its entirety.

### INDUSTRIAL APPLICABILITY

The antenna apparatus according to the present disclosure is suitable for applications to antenna apparatuses for performing communication using a plurality of antennas.

### REFERENCE SIGNS LIST

1, 2, 3, 4, 5 Antenna apparatus
10 Ground plane
20a, 30a, 40a, 50a First ground plane
20b, 30b, 40b, 50b Second ground plane
11, 21, 31, 41, 51 First antenna
11a, 21a, 31a, 41a, 51a First element
11b, 21b, 31b, 41b, 51b Second element
12, 22, 32, 42, 52 Second antenna
12a, 22a, 32a, 42a, 52a Third element
12b, 22b, 32b, 42b, 52b Fourth element
13, 23, 35, 45, 53 First power feeding point
14, 24, 36, 46, 54 Second power feeding point
33, 43 Third antenna
33a, 43a Fifth element
33b, 43b Sixth element
34, 44 Fourth antenna
34a, 44a Seventh element
34b, 44b Eighth element
37, 47 Third power feeding point
38, 48 Fourth power feeding point

1. An antenna apparatus, comprising:
a first antenna;
a second antenna;
a first ground plane to which the first antenna is connected via a first power feeder; and
a second ground plane to which the second antenna is connected via a second power feeder, wherein
the first ground plane and the second ground plane are provided substantially in parallel with each other.

2. The antenna apparatus according to claim 1, wherein the second antenna is provided on a same side as the first antenna with respect to the first ground plane.

3. The antenna apparatus according to claim 2, wherein the first antenna is an antenna to be connected to a corner portion of the first ground plane, and the second antenna is an antenna to be connected to a corner portion of the second ground plane, the corner portion of the second ground plane being positioned diagonally to the corner portion of the first ground plane.

4. The antenna apparatus according to claim 3, wherein the first antenna and the second antenna each include a partly-bent element.

5. The antenna apparatus according to claim 4, wherein a portion of the partly-bent element in the first antenna and a portion of the partly-bent element of the second antenna extend in directions substantially opposite to each other.

6. The antenna apparatus according to claim 3, wherein the second ground plane includes, at another corner portion of the second ground plane positioned diagonally to the corner portion of the second ground plane, a notch through which the first antenna passes.

7. The antenna apparatus according to claim 4, wherein a distance between the first ground plane and the second ground plane is equal to or greater than 2 mm and is not greater than (16−2t/5) mm in a case where the first ground plane and the second ground plane are each a rectangular ground plane, and a length of a long side of each of the first ground plane and the second ground plane is equal to or greater than 70 mm and is not greater than 90 mm, and a length of a short side of each of the first ground plane and the second ground plane is (25+t) mm, where t is equal to or greater than 10 and is not greater than 20.

8. The antenna apparatus according to claim 2, further comprising a third antenna, wherein
the third antenna is connected to the first ground plane via a third power feeder, and wherein
the third antenna is provided on a side of the first ground plane and the second ground plane which is opposite to a side of the first antenna and the second antenna.

9. The antenna apparatus according to claim 2, further comprising a fourth antenna, wherein
the fourth antenna is connected to the second ground plane via a fourth power feeder, and wherein
the fourth antenna is provided on a side of the first ground plane and the second ground plane which is opposite to a side of the first antenna and the second antenna.

10. The antenna apparatus according to claim 1, wherein the second ground plane includes a notch through which the first antenna passes.

11. The antenna apparatus according to claim 2, further comprising: a third antenna; and a fourth antenna, wherein
the third antenna is connected to the first ground plane via a third power feeder, and the fourth antenna is connected to the second ground plane via a fourth power feeder, and wherein
the third antenna and the fourth antenna are provided on a side of the first ground plane and the second ground plane which is opposite to a side of the first antenna and the second antenna.

12. The antenna apparatus according to claim 11, wherein
the third antenna is connected to another corner portion of the first ground plane positioned diagonally to the corner portion of the first ground plane where the second antenna is connected, and wherein
the fourth antenna is connected to a corner portion of the second ground plane positioned diagonally to a corner portion of the second ground plane where the first antenna is connected.

13. The antenna apparatus according to claim 11, wherein the third antenna and the fourth antenna each include a partly-bent element.

14. The antenna apparatus according to claim 13, wherein a portion of the partly-bent element in the third antenna and a portion of the partly-bent element of the fourth antenna extend in a same direction.

15. The antenna apparatus according to claim 11, wherein the first ground plane includes, at a corner portion of the first ground plane, a notch through which the fourth antenna passes.

16. The antenna apparatus according to claim 2, further comprising: a third antenna; and a fourth antenna, wherein
the third antenna is connected to the second ground plane via a third power feeder, and the fourth antenna is connected to the first ground plane via a fourth power feeder, and wherein
the third antenna and the fourth antenna are provided on a side of the first ground plane and the second ground plane which is opposite to a side of the first antenna and the second antenna.

17. The antenna apparatus according to claim 16, wherein
the third antenna is connected to a corner portion of the second ground plane positioned diagonally to the corner portion of the first ground plane where the second antenna is connected, and wherein
the fourth antenna is connected to a corner portion of the first ground plane positioned diagonally to the corner portion of the second ground plane where the first antenna is connected.

18. The antenna apparatus according to claim 16, wherein the third antenna and the fourth antenna each include a partly-bent element.

19. The antenna apparatus according to claim 18, wherein a portion of the partly-bent element in the third antenna and a portion of the partly-bent element of the fourth antenna extend in a same direction.

20. The antenna apparatus according to claim 16, wherein the first ground plane includes, at a corner portion of the first ground plane, a notch through which the third antenna passes.
